(19) United States
(12) Patent Application Publication
(10) Pub. No.: US 2013/0305510 A1
(43) Pub. Date: Nov. 21, 2013

(54) WHEEL PULLER

(71) Applicants: Andrew James Eastman, Westminster, CO (US); Daniel Alan Harrelson, Westminster, CO (US)

(72) Inventors: Andrew James Eastman, Westminster, CO (US); Daniel Alan Harrelson, Westminster, CO (US)

(21) Appl. No.: 13/668,464

(22) Filed: Nov. 5, 2012

Related U.S. Application Data
(60) Provisional application No. 61/555,792, filed on Nov. 4, 2011.

(51) Int. Cl. B60B 29/00

(52) U.S. Cl. CPC B60B 29/008
USPC 29/426.5; 29/252

(57) ABSTRACT

A device with actuating assistance that can remove a wheel from a vehicle is presented and, in particular, an apparatus and method that can efficiently, reliably and safely remove a wheel rusted or otherwise semi-permanently attached to a vehicle. An additional aspect is to provide a device that may be a hand tool and that may engage a hydraulic actuating device. Further, the apparatus may be configured to engage other hard to remove components, such as rusted over sub-assemblies of industrial machinery.

### CROSS REFERENCE TO RELATED APPLICATION

The present application claims the benefits of and priority to U.S. Provisional Application Ser. No. 61/555,792, filed Nov. 4, 2011, entitled “WHEEL PULLER,” which is incorporated herein by reference in its entirety for all that it teaches and for all purposes.

### FIELD

A device with actuating assistance that removes a wheel from a vehicle is presented and, in particular, an apparatus and method that efficiently, reliably and safely removes a wheel rusted or otherwise semi-permanently attached to a vehicle.

### BACKGROUND

Heavy vehicles, such as trucks, tractors, heavy construction equipment and the like, utilize large, heavy tandem or single wheels which are difficult to handle and service. All such vehicles require regular periodic servicing during which these large wheels are removed to facilitate such repairs as brake work and bearing lubrication, for example. The rigorous maintenance demands of interstate truck fleets require continual maintenance operations wherein the heavy tandem wheels, weighing several hundred pounds per pair, are serviced manually, requiring removal of the lugs, lifting off of the wheels, inspection and servicing the equipment, then laboriously lifting the wheels back into position and securing them. Often, the wheels of such vehicles become stuck, typically due to rust or corrosion; the wheel hub cannot be removed.

The prior art traditionally uses mechanical means to remove a stuck wheel from a vehicle. These devices are typically heavy and use mechanical means to engage a wheel hub and to effect the removal of the wheel and tire combination. Because of their ineffectiveness, high cost, and difficulty of use, many users attempt a variety of ad hoc methods to remove a stuck wheel, to include repeatedly striking the tire with hammers, applying heat to the hub area, such as with a blow-torch, and even removing the lug nuts and driving the vehicle to urge the wheel to loosen.

For example, U.S. Pat. No. 2,903,049 issued to Carlson on Sep. 8, 1959 (“Carlson”) teaches a tire and wheel dolly comprising a portable platform and a semi-circular clamp mounted on the platform for rotation within a vertical plane. Each end of the clamp has a swivelly-mounted curved plate for releasably supporting the diametrically opposite sides of a wheel assembly for rotation about the wheel diameter. Also, an adjustable wheel block is removably secured to the platform for rigidly supporting the wheel assembly in a horizontal plane independently of the clamp. Further, the clamp includes an integral transverse shaft rotatably secured to the platform, a pinion fixed to the shaft and a rear gear supported for reciprocating longitudinal movement on the platform in constant meshing engagement with the pinion. A hydraulic means for selectively moving the rack gear between an extended and a retracted position is provided. The platform includes an opening for receiving a lower portion of a supported wheel assembly, a reciprocating hydraulic plunger at each side of the opening, and plungers being in axial alignment and adapted to simultaneously engage opposite side walls of a position tire. Carlson employs a traditional mechanical means of tire removal and is not a hand tool. Carlson is incorporated by reference in its entirety for all purposes.

U.S. Pat. No. 3,847,294 issued to Davenport on Nov. 12, 1974 (“Davenport”) teaches a device which aids in safe, efficient removal of heavy truck wheels for replacement or repair. In Davenport, a dual wheel remover, which is mounted on a combination of fixed and swivel type casters, is positioned and moved by one individual, and with the tilting adjustable feature, allows the wheels to be easily removed from the vehicle and securely transported, without the necessity of the operator of the device to physically handle the wheel units. Like Carlson, Davenport employs a traditional mechanical means of tire removal and is not a hand tool. Davenport is incorporated by reference in its entirety for all purposes.

U.S. Pat. No. 5,315,745 issued to Cantwell et al on May 31, 1994 (“Cantwell”) teaches an improved tool for installing and removing a hub on a shaft. Cantwell uses two sequential assembly configurations of a first screw, a nut, a thrust bearing, and a cup accomplish installation. Two additional sequential assembly configurations of the first screw, the nut, two plates, clamping members, a second screw, a pin, and a ball accomplish tool alignment and hub removal. Cantwell employs a traditional mechanical means of tire removal. Cantwell is incorporated by reference in its entirety for all purposes.

U.S. Pat. No. 7,766,306 issued to Morey on Aug. 3, 2010 (“Morey”) teaches a device for removing a vehicle wheel end assembly includes a base having an upright section; and a hub support movable with respect to the upright section, the hub support having a first section translatable with respect to the upright section, and a hub adaptor pivotally connected to the first section so as to permit the hub adaptor to be angled with respect to the first section. A method for servicing ball joints of a motor vehicle includes jacking the motor vehicle so that a wheel is off the ground; removing a wheel from a wheel hub; removing the wheel end assembly including the wheel hub from the vehicle having ball joints using a device supporting the entire wheel end assembly; and servicing the ball joints of the motor vehicle. Morey employs a traditional mechanical means of tire removal and is not a hand tool. Morey also is silent regarding a means to urge stuck wheels from a vehicle. Morey is incorporated by reference in its entirety for all purposes.

U.S. Pat. No. 6,913,248 issued to Schmitz on Jul. 5, 2005 (“Schmitz”) teaches a vehicle lifting and wheel removal combination system includes a hydraulic pump mounted on a vehicle. Each of a plurality of hydraulic jacks is fluidly coupled to the hydraulic pump. Each of the hydraulic jacks is mounted to a frame of the vehicle. A plurality of actuators is operationally coupled to the hydraulic pump for selectively positioning each of the hydraulic jacks in an extended position or a retracted position. A plurality of air compressors is mounted to the vehicle and each is operationally coupled to the power supply. Each of a plurality of air lines is fluidly coupled to one of the air compressors. Each of the air lines has a free end having a first mating portion coupled thereto. A pneumatic impact gun for removing lug nuts has a second mating portion for selectively coupling to one of the first mating portions of the air lines. Although Schmitz employs hydraulics to move its vehicle, it is silent regarding a means to urge stuck wheels from a vehicle. Schmitz is incorporated by reference in its entirety for all purposes.

U.S. Pat. No. 4,042,139 issued to Pernsteiner et al. on Aug. 16, 1977 (“Pernsteiner et al.”) teaches a wheel-removing and handling dolly device for dual or single-tired vehicle wheel assemblies consisting of a wheeled base having an upstanding post containing a hydraulic lifting ram cylinder whose piston rod is connected to a carriage assembly slidably engaged on the post. Respective gripping lever arms are provided on opposite sides of the carriage assembly, the lever arms having tire-gripping members horizontally pivoted to their outer end portions adapted to grippingly engaged diametrically opposite portions of a wheel assembly. The inner end of one of the lever arms is operatively connected to a hydraulic clamping cylinder assembly. A hydraulic wheel puller cylinder is carried horizontally by the carriage, extending between the gripping lever arms and having an extensible piston rod provided with a wheel hub-engaging head portion. A manually operated ram pump is carried on the carriage assembly and is connected through respective control valves to the lifting cylinder, the clamping cylinder and the wheel puller cylinder. After a wheel assembly is clamped and pulled from a vehicle, the wheel assembly can be rotated to a horizontal position, providing access to its brake drum or other parts for repair, cleaning or other servicing operations. Pernsteiner grips the exterior outside of a tire during removal, yet is not a hand tool and does not engage the inner attachment section of a wheel, e.g. the wheel hub. Also, it is unlikely Pernsteiner would be effective in removal of stuck tires from vehicles. Pernsteiner is incorporated by reference in its entirety for all purposes.

U.S. Pat. No. 3,830,387 issued to Virnig on Aug. 20, 1974 (“Virnig”) teaches a vehicle wheel handling apparatus for holding and manipulating heavy vehicle wheels of single or tandem nature, comprises a frame including an upright post with a slidably mounted carriage thereon having wheel engaging means such as a pair of arms swingably mounted relative to one another, each arm having a pivotally mounted wheel engaging member adjacent the end thereof. Means are provided for tightening the wheel engaging means on single or tandem vehicle wheels to retain the wheels. A wheel removing mechanism is provided to urge hard to remove wheels from the vehicle. The apparatus permits single or tandem vehicle wheels to be lifted from the vehicle axle, moved about, retained during servicing, or pivoted about a horizontal axis by an operator. Virnig employs traditional mechanical means of engaging a tire and the exterior outside of a tire during removal, yet is not a hand tool and does not engage the inner attachment section of a wheel, e.g. the wheel hub. Virnig employs a worm gear mechanism to assist in wheel removal. Virnig is incorporated by reference in its entirety for all purposes.

Therefore, there is a long-felt need for a device that may effectively, reliably and safely remove a stuck wheel from a vehicle. The present device and method of operation addresses and resolves these needs.

A device with actuating assistance that removes a wheel from a vehicle is presented and, in particular, an apparatus and method that efficiently, reliably and safely removes a wheel rusted or otherwise semi-permanently attached to a vehicle. An additional aspect of one embodiment is to provide a device that is a hand tool and that may engage a hydraulic actuating device. Further, the apparatus may be configured to engage other hard-to-remove components, such as rusted over sub-assemblies of industrial machinery.

### SUMMARY

A device with actuating assistance that can remove a wheel from a vehicle is presented and, in particular, an apparatus and method that can efficiently, reliably and safely remove a wheel rusted or otherwise semi-permanently attached to a vehicle.

In one embodiment, a wheel-removing device to remove a wheel from a vehicle is disclosed, the device comprising: a cylindrical body having a first end and a second end; an actuating arm, the actuating arm connected to the cylindrical body and configured to extend the cylindrical body; an attachment sleeve connected to the first end, the attachment sleeve configured to engage a wheel hub of a wheel; an attachment port, the attachment port formed on the second end and configured to engage a hydraulic actuation pump; and at least one strap; wherein the at least one strap is a nylon strap and is configured to connect the second end and a wheel rim of the wheel; wherein when the hydraulic actuation pump is actuated, a hydraulic fluid passes through the attachment port and urges the actuating arm to an extended position, therein generating a force from the attachment sleeve to the wheel hub and generating a force in the opposing direction by the at least one strap to the wheel rim, wherein the wheel is removed from the vehicle.

In another embodiment, a system to remove a wheel from a vehicle is disclosed, the system comprising: a body having a first end and a second end; an actuating arm, the actuating arm interconnected to the body and configured to extend the body; an attachment sleeve interconnected to the first end, the attachment sleeve adapted to engage a wheel hub of a wheel; an attachment port, the attachment port adapted to be in fluid communication with an actuating pump; and at least one strap; wherein the at least one strap is configured to connect the second end and a wheel rim of the wheel; wherein when a user engages the actuating pump so as to extend the actuating arm, a force is applied by the first end to the wheel hub, and a substantially opposite force is applied by the at least one strap to the wheel rim, wherein the wheel is removed from the vehicle.

In a further embodiment, a method to remove a wheel from a vehicle is disclosed, the method comprising the steps of: providing a wheel-removing device, the device comprising: a cylindrical body having a first end and a second end; an actuating arm, the actuating arm connected to the cylindrical body and configured to extend the cylindrical body; an attachment sleeve connected to the first end, the attachment sleeve configured to engage a wheel hub of a wheel; an attachment port, the attachment port formed on the second end and configured to engage an actuation pump; at least one strap; positioning the attachment sleeve against the wheel hub of a wheel of a vehicle; attaching the at least one strap between a wheel rim of the wheel and the second end; connecting the actuating pump to the attachment port; and activating the actuating pump wherein fluid passes through the attachment port and urges the actuating arm to an extended position, therein generating a force from the attachment sleeve to the wheel hub and generating a force in the opposing direction by the at least one strap to the wheel rim, wherein the wheel is removed from the vehicle.

In one embodiment, the device comprises a first end and second end, attachment sleeve, base plate and attachment nut. In addition, the device features an actuating arm, body, attachment sleeve, base plate and tabs, each tab with a tab hole. The device fits to an actuating device through an attachment port. The attachment port is at the device's second end. The actuating arm is extendable. Each of the tabs includes a tab hole and strap hooks. When in operation, the actuating arm extends.

Embodiments of the tabs comprise several configurations. In one embodiment of the tabs, the device is configured with four tabs equally spaced apart radially, each tab comprising a tab hole. In another embodiment, the tabs are not spaced evenly, and comprise at least two tabs separated by a distance tab angle α. One embodiment comprises four tabs: one tab at a 0 degree radial; a second at a 180 degree radial; a third tab at a 144 degree radial; and a forth tab at a 216 degree radial. In this configuration, the third and forth tabs are separated by 72 degrees. In another embodiment, there are two tabs, one at a 0 degree radial and a second at a 180 degree radial.

The device comprises a tubular or cylindrical structure, configured to engage an actuating pump (at device's second end), and configured to operate as an actuating arm. At the end opposite to the end that engages the actuating pump (the device first end), the device is fitted with a base plate, attachment sleeve, and attachment nut. The device is further fitted with one or more tabs, each tab configured with a tab hole and strap hooks engaged at the tab hole. The strap hooks are configured to engage one or more attachment straps.

To operate the device, a user grasps the device and fits the attachment sleeve at the device's first end to a wheel hub, typically around the wheel hub, yet at an inside radius to the lug nuts of a tire (the tire assembly comprises lug nuts, wheel rim and wheel hub). Attachment straps are then fitted to the wheel rim, typically threaded around structural gaps in the wheel rim, and then fitted or connected to the strap hooks. The device is then fitted to an actuating device at the device's second end, which enables the actuating device to impart a force toward the wheel rim from the base plate and a substantially opposite force via the straps to the wheel rim, thereby pulling or urging the tire assembly off or away from its mounted position.

The user may also optionally place one or more lug nuts to the tire hub (yet not tighten completely, in one embodiment one-half inch from contact with wheel hub) so that when the wheel is pulled or broken-away from its stuck position, the wheel contacts the lug nuts and cannot drop away from its mounted position.

In one embodiment, the actuating means is a hydraulic pump, and in another embodiment specifically a 10 inch stroke 10 ton hydraulic cylinder. Other embodiments use a pneumatic pump to effect actuation of the actuating arm. In other embodiments, other means of actuating may be used. The actuating means may also be affected by hand, for example, a hand-pumped hydraulic pump. As used herein, the term “fluid” includes air and/or gases such as used in pneumatic pumps, and liquids, such as a hydraulic fluids used in hydraulic pumps.

The device's first end portion (that engages the tire hub) may be of several geometries. In one embodiment, the device's first end configuration comprises a circular attachment sleeve that attaches to the device with a base plate and attachment sleeve. Other embodiments use a pin threaded between the device's first end the attachment sleeve and/or base plate. In other embodiments, other means of attachment may be used.

The straps are, in one embodiment, made of high-strength nylon, but other materials of construction and type may be used. In one embodiment, the straps interconnect with the wheel by any of several means to include, but not be limited to, mechanical connectors, such as nuts and bolts, rivets, and solder, and chemical devices, such as glue, electrical devices, magnetic devices, and electro-mechanical devices. Further, the attachment means may include any known means to attach or interconnect two devices.

In other embodiments, the straps of the device or the device may be fitted with an abrasive or otherwise gripping material or gripping means to assist in the secure engagement of the device to the wheel hub and/or assist the user in gripping the device. Such abrasive material may include a rubber material and/or a sand-paper-like material.

In another embodiment, the device is a hand-tool.

In another embodiment, the device and method are adapted for use with removal of wheel hubs used on heavy duty trucks, such as Ford E-150, 250, 350, 450, 550 and Super Duty series vans and F-150, 250, 350, 450, 550 and Super Duty series pick-up trucks.

The device may be configured to engage specific wheel types. For example, the attachment sleeve designed with a specific radius to engage a wheel rim at a radius inside of the lug nuts.

In another embodiment, the device is adapted to engage-with and/or complement known actuating products. For example, the device may engage hydraulic ram actuation devices, such as Porta Power types of devices, for one or more of the device's actuating arm and body and/or to effect actuation of the device's actuating arm. Porta Power types of devices include, but are not limited to, Jacko™ 10 Ton Foot Hydraulic pumps. Actuation may be provided by manual means, e.g. by hand pump, or automatically, e.g. via electrical power. In one embodiment, one or more tabs may be fitted to the hydraulic ram actuation device. Similarly, the device may engage available pneumatic ram actuating cylinders for one or more of the device's actuating arm and body.

Also, in another embodiment the device may be configured to assist and/or enable the removal of other items beyond wheels stuck to vehicles. For example, the device may be configured to engage sub-assemblies of larger mechanical devices.

One of ordinary skill in the art will appreciate that embodiments of the present disclosure may be constructed of materials known to provide, or predictably manufactured to provide, the various aspects of the present disclosure. These materials may include, for example, stainless steel, titanium alloy, aluminum alloy, chromium alloy, and other metals or metal alloys. These materials may also include, for example, carbon fiber, ABS plastic, polyurethane, and other fiber-encased resinous materials, synthetic materials, polymers, and natural materials. The device and its elements could be flexible, semi-rigid, or rigid and made of materials such as stainless steel, titanium alloy, aluminum alloy, chromium alloy, and other metals or metal alloys, carbon fiber, ABS plastic, polyurethane, and other fiber-encased resinous materials, synthetic materials, polymers, and natural materials.

This Summary neither intended, nor should it be construed to be, representative of the full extent and scope of the present disclosure. The present disclosure is set forth in various levels of detail in the Summary, as well as in the attached drawings and the Detailed Description, and no limitation as to the scope of the present disclosure is intended by either the inclusion or non-inclusion of elements, components, etc., in this Summary. Additional aspects of the present disclosure will become more readily apparent from the Detailed Description, particularly when taken together with the drawings.

The above-described benefits, embodiments, and/or characterizations are not necessarily complete or exhaustive and, in particular, as to the patentable subject matter disclosed herein. Other benefits, embodiments, and/or characterizations of the present disclosure are possible utilizing, alone or in combination, as set forth above and/or described in the accompanying figures and/or in the description herein below, subject matter in this disclosure. However, the Detailed Description, the drawing figures, and the exemplary claim set forth herein, taken in conjunction with this Summary, define the patentable subject matter.

### BRIEF DESCRIPTION OF THE DRAWINGS

The accompanying drawings, which are incorporated in and constitute a part of the specification, illustrate embodiments and, together with the general description given above and the detailed description of the drawings given below, serve to explain the principals of the patentable material.

FIG. 1A is an end view of an embodiment of a wheel puller device.

FIG. 1B is a side view of an embodiment of a wheel puller device of FIG. 1A.

FIG. 1C is a side view of an embodiment of a wheel puller device with extended actuating arm.

FIG. 2A is a side view of a portion of an embodiment of a wheel puller device comprising the body section.

FIG. 2B is a partial view of an embodiment of a wheel puller device with extended actuating arm.

FIG. 3 is the disassembled first end of an embodiment of a wheel puller device.

FIG. 4A is a front view of an embodiment of the body of a wheel puller device configured with four tabs.

FIG. 4B is a front view of another embodiment of the body of a wheel puller device configured with two tabs.

FIG. 4C is a front view of another embodiment of the body of a wheel puller device configured with four equally-spaced tabs.

FIG. 5 is a side view of an embodiment of a wheel puller device engaged with a wheel hub and tire without straps.

FIG. 6 is a perspective view of an embodiment of a wheel puller device engaged with a tire and wheel with straps engaged to wheel rim and the device engaged with an actuating pump.

It should be understood that the drawings are not necessarily to scale. In certain instances, details that are not necessary for an understanding of embodiments or that render other details difficult to perceive may have been omitted. It should be understood, of course, that the patentable material is not necessarily limited to the particular embodiments illustrated herein.

### DETAILED DESCRIPTION

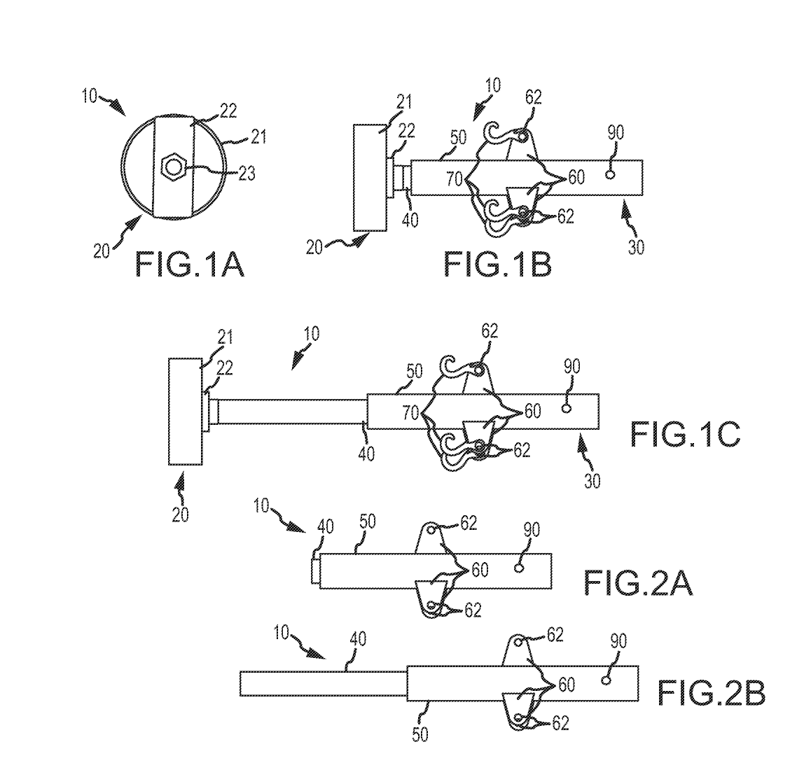

FIGS. 1-6 depict the device alone and as engaged with a tire and wheel.

Turning to FIGS. 1A-C, the device 10 is depicted with first end 20 and second end 30. FIG. 1A is an end view of the device 10. FIG. 1A depicts the device 10 with first end 20, attachment sleeve 21, base plate 22 and attachment nut 23. FIG. 1B depicts a side view of the device of FIG. 1A. FIG. 1B depicts the device 10 with first end 20, second end 30, actuating arm 40, body 50 and tab 60. In addition, FIG. 1B depicts attachment sleeve 21, base plate 22 and tabs 60, each with tab hole 62. Also depicted in FIG. 1B is attachment port 90. FIG. 1C depicts a side view of the device with extended actuating arm. FIG. 1C presents the device 10 with first end 20, second end 30, actuating arm 40, body 50, tabs 60, and attachment port 90. Each of the tab 60 includes tab hole 62 and strap hooks 70. FIG. 1C is depicted with actuating arm 40 extended as would be the configuration when removing a wheel from a wheel hub.

FIGS. 2A-b depict the device 10 without its engaged tire end. FIG. 2A depicts a side view of a portion of the device comprising the body section. FIG. 2A presents the device 10 with actuating arm 40, body 50, attachment port 90 and three tab 60s, each with tab hole 62. FIG. 2B depicts a partial view of the device with extended actuating arm. FIG. 2B depicts the device 10 with actuating arm 40 extended from body 50. FIG. 2B also depicts attachment port 90 and three tab 60s, each with tab hole 62.

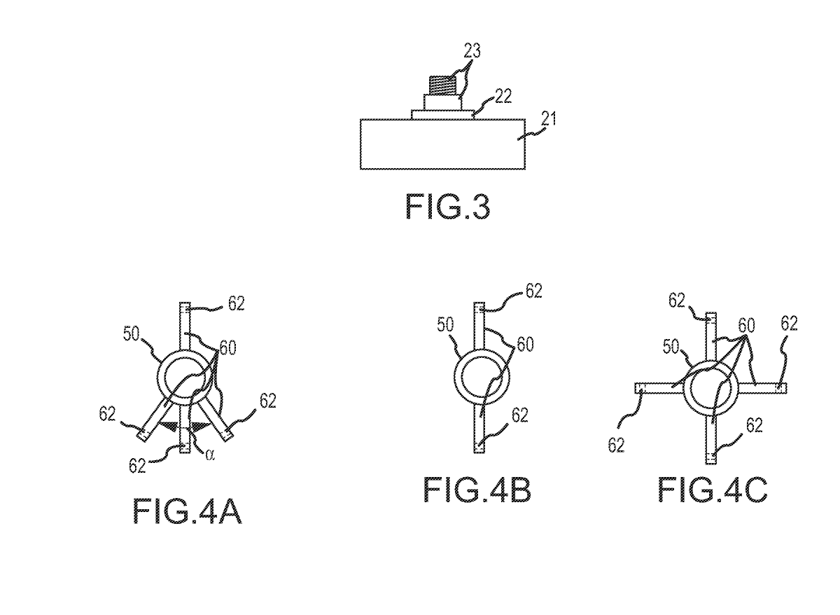

FIG. 3 depicts the disassembled first end of the device. FIG. 3 depicts the attachment sleeve 21, base plate 22 and attachment nut 23.

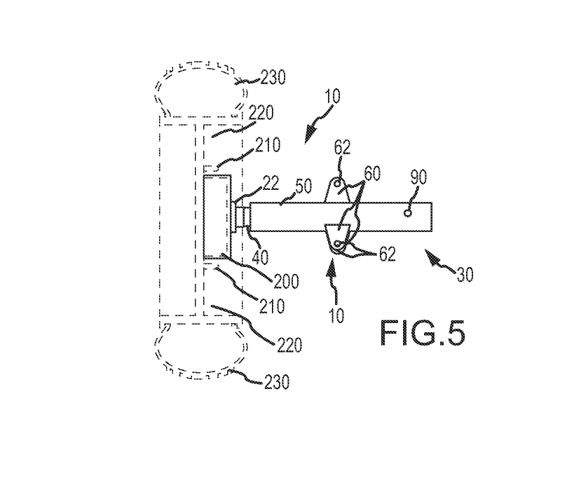

FIGS. 4A-C depict three embodiments of the body 50 with associated tab 60. FIG. 4A depicts a front view of one embodiment of the body of the device configured with four tabs. FIG. 4A presents the embodiment of the body 50 with four tab 60s, each tab 60 comprising a tab hole 62. Further, FIG. 4A depicts two of the lower tabs 60 separated by a distance tab angle α. FIG. 4B depicts an alternate a front view of an alternate embodiment of the device depicting the body of the device with two tabs. In FIG. 4B, body 50 is depicted with two equidistant tab 60s, each with tab hole 62. FIG. 4C depicts a front view of one embodiment of the body of the device configured with four equal spaced tabs. FIG. 4C presents body 50 with four equidistant tab 60s, each of which comprise tab hole 62.

FIG. 5 depicts a side view of the device engaged with a wheel hub and tire without straps. FIG. 5 describes the device 10 with first end 20, second end 30, actuating arm 40, body 50, three tab 60s, each with tab hole 62 and attachment port 90. FIG. 5 depicts the device 10 engaged with wheel hub 200. Wheel hub 200 is engaged with wheel rim 220 and concentric with tire 230. Lug nuts 210 are also depicted. In FIG. 5, the device 10 engages the wheel hub 200 at the device 10 first end 20.

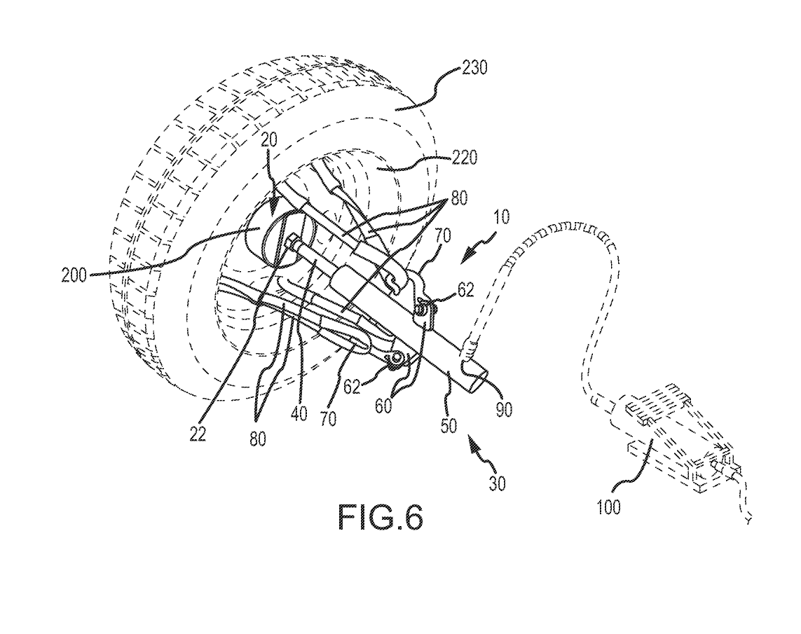

FIG. 6 depicts a perspective view of the device engaged with a tire and wheel with straps engaged to wheel rim and device engaged with actuating pump. FIG. 6 presents the device 10 with the first end 20, second end 30, actuating arm 40, body 50, tab 60 with tab hole 62 and strap hook 70. Strap hook 70s are engaged with straps 80 which wrap around wheel rim 220. The device 10 engages the wheel hub 200 at device 10 first end 20. A secure fit is obtained by lashing straps 80 around wheel rim 220 and as wrapped around strap hook 70. Once straps are tightened, the device is engaged in fluid communication through attachment port 90 to an actuating pump 100. The actuating pump 100 supplies hydrolic means or other actuating means to the device 10 such that extension actuating arm 40 extends against wheel hub 200, thereby applying pressure against wheel hub 200 while simultaneously exerting pressure through straps 80 in the opposite direction. The effect is to pull wheel rim 220 from its attachment point.

One of ordinary skill in the art will appreciate that embodiments of the present disclosure as provided in FIGS. 1-6 may allow the device 100 to engage and remove/replace any wheel or assembly fitted to a vehicle hub or mechanical device, for example, to engage and remove a subassembly such as a propane tank rusted to a recreational vehicle.

To provide further clarity to the Detailed Description provided herein in the associated drawings, the following list of components and associated numbering are provided as follows:

| No. | Component |
|---|---|
| 10 | Device |
| 20 | First End |
| 21 | Attachment Sleeve |
| 22 | Base Plate |
| 23 | Attachment Nut |
| 30 | Second End |
| 40 | Actuating Arm |
| 50 | Body |
| 60 | Tabs |
| 62 | Tab Holes |
| 70 | Strap Hooks |
| 80 | Straps |
| 90 | Attachment Port |
| 100 | Actuating Pump |
| 200 | Wheel Hub |
| 210 | Lug Nuts |
| 220 | Wheel Rim |
| 230 | Tire |
| α | Tab Angle |

What is claimed is:

1. A wheel-removing device to remove a wheel from a vehicle, comprising:
a cylindrical body having a first end and a second end;
an actuating arm, the actuating arm connected to the cylindrical body and configured to extend the cylindrical body;
an attachment sleeve connected to the first end, the attachment sleeve configured to engage a wheel hub of a wheel;
an attachment port, the attachment port formed on the second end and configured to engage a hydraulic actuation pump; and
at least one strap;
wherein the at least one strap is a nylon strap and is configured to connect the second end and a wheel rim of the wheel;
wherein when the hydraulic actuation pump is actuated, a hydraulic fluid passes through the attachment port and urges the actuating arm to an extended position, therein generating a force from the attachment sleeve to the wheel hub and generating a force in the opposing direction by the at least one strap to the wheel rim, wherein the wheel is removed from the vehicle.

2. The device of claim 1, wherein the device is a hand tool.

3. The device of claim 1, wherein the attachment sleeve is substantially circular in cross-section.

4. The device of claim 1, wherein the body, the actuating arm and the attachment port form a detachable element.

5. The device of claim 1, wherein the attachment sleeve is connected to the front end by an attachment nut.

6. The device of claim 1, wherein the at least one strap is attached to a hook and the body comprises at least one tab, wherein the hook engages the at least one tab.

7. The device of claim 6, wherein the at least one tab is a plurality of tabs arranged concentrically about the circumference of the body.

8. The device of claim 1, wherein the actuating arm is concentric with the cylindrical body.

9. A system to remove a wheel from a vehicle, comprising:
a body having a first end and a second end;
an actuating arm, the actuating arm interconnected to the body and configured to extend the body;
an attachment sleeve interconnected to the first end, the attachment sleeve adapted to engage a wheel hub of a wheel;
an attachment port, the attachment port adapted to be in fluid communication with an actuating pump; and
at least one strap;
wherein the at least one strap is configured to connect the second end and a wheel rim of the wheel;
wherein when a user engages the actuating pump so as to extend the actuating arm, a force is applied by the first end to the wheel hub, and a substantially opposite force is applied by the at least one strap to the wheel rim, wherein the wheel is removed from the vehicle.

10. The system of claim 9, wherein the system is a hand tool.

11. The system of claim 9, wherein the actuating pump is a hydraulic pump.

12. The system of claim 9, wherein the attachment sleeve is substantially circular in cross-section.

13. The system of claim 9, wherein the body, the actuating arm and the attachment port form a detachable element.

14. The system of claim 9, wherein the attachment sleeve is connected to the front end by an attachment nut.

15. The system of claim 9, wherein the at least one strap is attached to a hook and the body comprises at least one tab, wherein the hook engages the at least one tab.

16. The system of claim 15, wherein the at least one tab is a plurality of tabs arranged concentrically about the circumference of the body.

17. The system of claim 9, wherein the at least one strap is a nylon strap.

18. The system of claim 9, wherein the actuating pump is a pneumatic pump.

19. A method to remove a wheel from a vehicle, comprising the steps of:
providing a wheel-removing device, the device comprising:
a cylindrical body having a first end and a second end;
an actuating arm, the actuating arm connected to the cylindrical body and configured to extend the cylindrical body;
an attachment sleeve connected to the first end, the attachment sleeve configured to engage a wheel hub of a wheel;
an attachment port, the attachment port formed on the second end and configured to engage an actuation pump;
at least one strap;
positioning the attachment sleeve against the wheel hub of a wheel of a vehicle;
attaching the at least one strap between a wheel rim of the wheel and the second end;
connecting the actuating pump to the attachment port; and
activating the actuating pump wherein fluid passes through the attachment port and urges the actuating arm to an extended position, therein generating a force from the attachment sleeve to the wheel hub and generating a force in the opposing direction by the at least one strap to the wheel rim, wherein the wheel is removed from the vehicle.

20. The method of claim 19, wherein the actuating pump is a hydraulic pump.
